(19) United States
(12) Patent Application Publication
(10) Pub. No.: US 2024/0212024 A1
(43) Pub. Date: Jun. 27, 2024

(54) CONTROL METHODS FOR DIGITAL SHOPPING CARTS

(71) Applicant: KBST GmbH, Kassel (DE)

(72) Inventors: Niels BECKER, Kaufungen (DE); Jan KRAUS, Kaufungen (DE)

(21) Appl. No.: 18/524,677

(22) Filed: Nov. 30, 2023

(30) Foreign Application Priority Data
Dec. 24, 2022 (EP) 22216674.6

(51) Int. Cl. G06Q 30/0601; G06Q 20/20; G06V 10/74

(52) U.S. Cl. CPC G06Q 30/0633; G06Q 20/208; G06Q 30/0641; G06V 10/761

(57) ABSTRACT

A method for digitally capturing and tracking products placed in a digital shopping cart when a control process reveals that a product has not been recognized or has not been recognized reliably enough, the method includes,
separately storing a copy of recorded image data from a time period of a specified length that shows placing the products in the shopping cart,
creating a marking for the not, or not reliably enough, recognized product in a digital product list,
automatically checking the product list for the presence of the product marked in the product list,
when a marked product is found, playing the separately stored copy of the image data for a time segment that shows the placing of the product in the shopping cart, and
offering a user interface in the checkout zone for separate re-registration of the marked product.

The present invention is in the field of digital shopping carts, which are equipped with a products shelf as a shelf cart or classically with a basket and a products support underneath for larger- volume products, and in the field of picking carts. In the following, these trolleys are simply referred to as “shopping carts”. The invention relates to a control method for determining whether all products in the shopping cart have been correctly recognized, according to the preamble of claim 1, and corresponding devices that are suitable for implementing this method.

### STATE OF THE ART

The delimitation of the present invention from the prior art is based on classic, digital “shopping carts” in retail, which are equipped with a digital products recognition system. These are referred to here as “digital shopping carts”.

Generic digital shopping carts in the narrower sense, as they are used in retail stores, are provided with a modern electronic user interface, often a type of tablet computer with a simplified display, with which a customer can registrate a product, for example by scanning it with a hand-held scanner connected to it before putting it in his shopping cart.

The digital shopping carts are equipped with various sensors in order to recognize the products that are placed in the rolling shopping cart as precisely and redundantly as possible in order to increase security against simply forgetting to register products and against misuse and theft of products. These include, for example, one or more cameras, one of which is attached to the shopping cart, but also cameras that are usually permanently installed on the ceiling in the store and record the “image of the products” in the shopping basket and the movement of the shopping cart.

Other sensors are scales that measure the weight of the products in the shopping cart basket and make it digitally available for program-controlled further processing.

Various other sensors such as radar and lidar sensors, magnetically sensitive sensors, Bluetooth transmitters, GPS trackers, etc. are used in the prior art to track the position of the shopping cart. All the data supplied by the sensors is automatically processed further under program control and is used to ensure that the products are paid for correctly and that no shopping cart itself will be stolen. For this purpose, the shopping carts are integrated into a WLAN that is active locally in the store. The recorded data can be processed locally in the store or in the cloud.

US patent application US 2022/0194454 A1 describes such a system.

Disadvantageously, however, user comfort is still too low, whether for a customer who is supposed to scan the products when they are placed in the cart and may make some mistakes, or for the cashier who is supposed to check whether all the products in the shopping cart are correctly recognized.

The object of the present invention is therefore to increase user comfort when using a digital shopping cart, in order to thereby significantly increase the acceptance of this system.

### ADVANTAGES OF THE INVENTION

The subject matter according to the invention with the features of claim 1 and the subject matter of the independent claims solve this problem.

Advantageous further developments and improvements of the respective subject matter of the invention can be found in the dependent claims.

The method according to the invention can be used to advantage in a retail store in which shopping carts, so-called Cash & Carry (C&C) trolleys, are used, be it a grocery store, a discount store, a home improvement store or whatever. It can also be used when picking products in wholesale or by employees in any logistics center, whenever it is important to select a certain number of certain products from a larger range of products and to bring them to another location separately using a mobile picking cart. The demarcation from the state of the art is done on classic, digital “shopping carts” in retail, which are equipped with a digital products registration system. These are referred to here as “digital shopping carts”. This system contains a so-called scan box, a camera and/or a scale that can measure the weight of products that have been or are to be placed into the cart. The term “Scanbox” is understood to mean an operable tablet computer or any other computer-aided hardware/software combination suitable for end customers or, in the case of order picking carts, for employees as an interface to the customer or employee, with a memory for storing code sections and a logic unit for execution of these code sections to perform corresponding steps of the methods of the invention below, and preferably with a robust touch display so that the user can easily recognize information from the system and provide input to the system.

According to a first aspect of the present invention, a method for recognizing and tracking products that are placed in the basket of a digital shopping cart when shopping is disclosed, comprising the following steps:

a) Permanent recording of image data of the shopping cart by at least one camera mounted on the shopping cart, which can film and preferably also generate photos with a higher resolution than the film frames, i.e. in any case generate image data, the image data generated by the camera during a time window—for example 5 seconds to 1 minute or longer—saved on a rolling basis and previously existing image data is overwritten; That is, the camera temporarily stores, for example, 30-seconds lasting film sequences in a first memory area and overwrites this memory area again while recording a subsequent 30-seconds lasting scene. The temporary memory is preferably on the scan box according to the invention on the shopping cart. However, the image data can also be transmitted via WLAN to a server in the shop or to a cloud.

b) Registering a placement process of a product into the shopping cart by means of automated evaluation of sensor data provided by sensors on the shopping cart. The events in and on the shopping cart are analyzed by a program module of the Scanbox using the sensor data, so that events can be defined that can be described as the “placement process of a product”. State-of-the-art technology is used for this, including the use of AI and machine learning. A precisely measuring weighing system can be applied advantageously as a sensor, but alternatively or in combination with the weighing system, the use of one or two, three or more cameras that is/are mounted on the cart, and their image data from the Al logic can be evaluated, as described in more detail below. With the appropriate quality of the image data and their evaluation logic, scales can be dispensable.

c) Carrying out an automated control process to determine whether the inlaid products have been recognized reliably enough. This can be done by scanning a standard barcode, by capturing an RFID code or the like, combined with automated recognition based on live images of the products, in particular with the help of AI methods and comparison in an existing products database, in which an image for each product is deposited. It can also alternatively or in combination be done with an exact recording of the actual weight of the inlaid products and by comparison with the expected target weight of the products, which can be taken from a products database available in the WLAN or in the local memory on the trolley. If the comparison of images and/or the comparison of the weights leads to differences that are greater than a specified, products-specific tolerance, the freshly inlaid products are marked as “not recognized reliably enough” in a digitally created list of products that is continuously updated during the purchase, see also point e) below.

d) if the control process shows that a product has not been recognized or has not been recognized reliably enough, then a copy of the recorded image data showing the registered placement process is saved separately from a time period of a specified length—for example 3 seconds before and 5 seconds after the scales or the image recognition has signaled the placement of the products. The scale communicates in real-time with the logic on the shopping cart's scanbox. Communication can be wired or wireless, for example via Bluetooth or a WLAN connection. The “scale” in the above context is a system of one or more, preferably three, so-called load cells that are mounted between the shopping basket and the cart frame of the shopping cart, each with an electronic measurement component and, if necessary, a measurement data amplifier and a wireless interface or with cables to the communication with the scan box logic on the shopping cart. This is already known from patent applications US 2015/0206121 A1 or DE 10 2018 132 059 A1. The load cells are mounted in such a way that they can precisely measure the load of products on all surfaces where the customer can place products.

The separately saved copy of the—in the example—8-seconds lasting time segment of the image data is preferably located locally in the memory of the scan box logic on the shopping cart and is preferably redundantly transmitted via WLAN together with the ID of the shopping cart to a control computer, which constantly logs the entire products recognition processes in the shop.

e) Creation of a marking for the not recognized or not reliably enough recognized products in a digital list of products, which represents the products placed in the shopping cart ; As a rule, during the purchase of 20 products, for example, a digital product list is created which, in addition to the shopping cart ID, has 20 entries, each of which contains a products ID, plain text describing the products and the measured actual weight of the products. Optionally and preferably, the time of placement, the location of placement in the shop, which can be narrowed down more precisely via Bluetooth beacons communicating with the scan box logic, can also be stored for each entry in the list of products. However, the customer only sees part of this data, namely the name, quantity and price of the products. If, for example, the customer has not registered two of the 20 products reliably enough or not at all, for example because he forgot to scan the products, the corresponding entries in this list of products are marked and made visible to the customer.

The recognition of the products on the shopping cart can be done using all usual and expedient methods, such as a hand-held scanner connected to the scan box, which reads a code attached to the products, or a camera that takes one or more images while the products are being placed in the shopping cart, by RFID tags on the products and corresponding RFID readers, by NFC tags and NFC receivers, etc.

At the latest in the check-out zone or in the payment zone—or even during the purchase within the customer's autonomy—the following automated steps then take place in order to correctly register the insufficiently recognized products by the checkout staff or by the customer:
a) automated checking of the digital list of products created for the purchase for the presence of products marked in the list of products,
b) if marked products are encountered, playback of the separately stored copy of the image data from a period of predetermined length, which shows the placement process of the marked products in the shopping cart,
c) Offering a user interface in the checkout area or at the scan box of the shopping cart for separate re-registering of the marked products.

In the case of picking processes, these steps take place in a corresponding control zone, if necessary, supported by the corresponding control personnel.

This achieves a significant advantage over the control methods known in the prior art because the cashier no longer has to laboriously search around in the products in the shopping cart to see which products were insufficiently or not at all recognized. Instead, she can see the unsufficiently recognized products on her display in the short video that is played back, namely the complete process of how these products were placed in the cart. She can then selectively pick up these products and re-register them correctly—by scanning, manually entering the products identifier, or other suitable processes, as are known from the prior art.

If the customer is offered this option while shopping, he can place his products in the cart without having to worry about whether each product was correctly registered by him during the placement or not. The customer is therefore no longer irritated by possible error messages that appear on the scanbox display while shopping. This significantly increases customer acceptance of digitally controlled shopping, which is particularly useful for older or visually impaired customers. The customer can then, for example to make use of the waiting time in the checkout line, pick all the products on his digital shopping list that are marked as insufficiently recognized, because he can see them on the short video, and can re-registrate them at his leisure. The list of products is then continuously updated, and the number of insufficiently recognized products decreases.

In another variant of the procedure, the short videos are only visible to the checking staff in order to re-register the incorrectly registered products.

The automated processing of the products marked as “insufficiently recognized” can be carried out either by the software implemented in the scan box or by a cash register check module installed separately at the cash register. Here, the assignment to the specific shopping cart and the associated customer takes place by reading a shopping cart ID attached to the cart, for example by means of an RFID code robustly attached to the shopping cart or by NFC communication between the scan box on the shopping cart and a portable NFC element of the cash register check module, or via WLAN using the wagon ID and receipt number. The cash register check module can use this assignment to access the customer's specific digital list of products.

A further advantageous feature of the invention is an automated confidence evaluation implemented in the scan box program according to the invention, according to which a product is considered not to be recognized reliably enough, based on confidence data for the respective product recogniton. The recognition of a product is documented according to the type of products—specific aspects with a probability of 100% if it can be said with certainty that the recognition of the product is correct, and at a very low percentage, less than 20%, if the recognition of the product is unsuitable according to the dealer's point of view. Details on this are disclosed below. An important data source for this is the data that is supplied by the camera or cameras and by the weighing system. However, the automated confidence assessment mentioned can be based on a large amount of other information, which is generated via additional sensors and is preferably transmitted wirelessly to a receiver, which then forwards this data to the operated software: So an automated location definition of the regular shelf locations in the store may serve as an indication for a respective product if a product was not registered where it is on the shelf. This would significantly reduce the confidence data when registering this product, for example. This is based on a products placement map that assigns all products to their normal location in the store, be it on shelves or mobile structures, in freezers, etc. This can be done independently of the store layout, the type of assortment and the size of the assortment. The location of the shopping cart can be detected with sufficient accuracy using Bluetooth beacons, using WLAN or other suitable state-of-the-art technologies.

An advantageous development of the method according to the invention results from the fact that there are usually groups of products in a shop whose products have to be weighed if they are not sold individually. The classic cases are the products classes of fruit and vegetables. The labels that identify the products and assign them to such “weighing obligation products” should therefore preferably be marked in such a way that the weighing obligation is perceived by the automated recognition. In the same way, labels for products without a weighing obligation should be marked in such a way that this property is also recognized by the automated recognition. A downgrading of the confidence data also results, for example, in the event that a fruit label of the weighing obligation products “fruit” is scanned which, before being registered, is fraudulently or accidentally stuck onto a high-priced wine bottle and laid in, for example.

The inventive triggering of the check for products marked as “insufficiently recognized” in the shopping cart's list of products can be achieved by various events: For example, by reaching a “payment zone”, which can be defined using a locating method according to the prior art, or by passage of a light barrier, by pressing a button provided for this purpose at the checkout manned by a cashier or at a self-service checkout, at a payment station, on the Scanbox tablet that is permanently attached to the shopping cart or at the payment station, or by entering a transmission code at the checkout, by capturing an image of the shopping cart entering the checkout zone through one of several installed cameras, by passing a dedicated Bluetooth beacon, etc.

Advantageously, the method according to the invention can be carried out without having to access target weights that are stored in a products database if the captured image data are good enough. If the scanning process does not take place, a comparison between the image data of the products that were created during the placement of the products and one or more images stored for the products in the products database is then sufficient. If there is a weighing function on the shopping cart, the actual weight for this product can be recorded and saved both in the digital product list and in the products database. Since the products database of the store is in the cloud, the actual weights of products from multiple purchases at one location and from different locations of a store chain can be stored in the database. In this way, over time, an empirically collected database is created, which continuously improves the automated method of the invention. The method according to the invention can therefore be used at a later point in time, when sufficient actual weights for an article have been stored and its target weight has been stored, for example as the mean value of the actual weights, even without recording and evaluating image data.

It is of considerable advantage if a very precise scale enables the automated, validated teaching of the image data. If a camera first gets a scan and then the weight is verified by the scales, the certainty that the laid-in and weighed product is exactly the scanned product is high enough. The camera can then record images and “teach” the product for image recognition. If, after a sufficient “teaching time”, sufficient image data has been teached, the mere placement of a product into the cart without actual image capture can be sufficient for products recognition. The cart can then use the weight and the teached image data to say with sufficient certainty that a specific item has been laid in.

Weight measurement and scan code as described therefore represent a preferred variant in the products recognition according to the invention.

Summarizing, the method according to the invention not only increases user comfort, but is essential for the profitable use of the associated technology for recognizing products. Without the method according to the invention, this technology has a blocking effect for many customers, since they are on their own when registering a product and are overstrained as soon as something does not work smoothly. User-friendliness and security for the retailer are only satisfactorily combined by the method according to the invention.

According to the present invention, products are advantageously identified by image recognition methods from the prior art as an alternative or in combination to the weight measurement and the scan code. The following sources are examples:

For the basics:

Bishop, Christopher M. Neural networks for patterns recognition. Oxford university press, 1995.

For image classification:

Krizhevsky, Alex, Ilya Sutskever, and Geoffrey E. Hinton. “Imagenet classification with deep convolutional neural networks.” Communications of the ACM 60.6 (2017): 84-90. https://dl.acm.org/doi/abs/10.1145/3065386 last accessed on Nov. 22, 2022.

Or:

Rawat, Waseem, and Zenghui Wang. “Deep convolutional neural networks for image classification: A comprehensive review.” neural computation 29.9 (2017): 2352-2449. https://ieeexplore.ieee.org/abstract/document/8016501 last accessed on Nov. 22, 2022.

For object detection:

Redmon, Joseph, et al. “You only look once: Unified, real-time object detection.” Proceedings of the IEEE conference on computer vision and pattern recognition. 2016. https://www.cv-foundation.org/openaccess/content cvpr 2016/html/Redmon You Only Look CVPR 2016 paper.html last accessed on Nov. 22, 2022.

For retail product recognition:

Wei, Yuchen, et al. “Deep learning for retail product recognition: Challenges and techniques.” Computational intelligence and neuroscience 2020 (2020). https://www.hindawi.com/journals/cin/2020/8875910/ last accessed on Nov. 22, 2022.

Using “Object Detection”, the relevant image section is recognized and the individual product is recognized by means of “Image Classification”.

Neural networks store learned information in their structure and can thus form abstractions in order to classify images. This is disclosed, for example, in:

https://de.wikipedia.org/wiki/K%C3%BCnstliches_neuronales_Net Z

and in:

Convolutional Neural Network—Wikipedia for the so-called “Convolutional Neural Networks”, abbreviated here as CNN, which are primarily used in the machine processing of image or audio data.

These CNNs have to be trained with a lot of examples. These examples can be generated, for example, from live operation when using the method according to the invention in the training mode, in which an image is recorded with each scan/placement process. In this way, images are created under real light and ambient conditions with a clearly assigned product if it has been scanned by the customer beforehand.

You “feed” such a CNN, for example, 1000 different pictures in which someone has put a Coca Cola can in the car. In this way, the system learns what a Coca Cola can can look like and can then carry out a confidence assessment on previously unseen live images based on almost matches found in order to recognize a Coca Cola can as such in a live image.

In order to use such a system for other product areas, it is trained with new example images from the respective other product area. The entire system remains the same.

A similar procedure can be used to check whether the recognition is correct, in which it is sufficient in many places to recognize just one product family, for example the “Coca Cola can” family, regardless of whether it is a can with sweetened cola or “Cola-Zero” or “Cola-Caffeine-Free” etc. This makes training easier and makes the system more robust. A so-called “negative identification” can also be used for this purpose, for example if someone weighs a bottle of wine for a scan code from bananas. The weight fits, of course, but the camera logic sees that they are definitely not bananas. This means that, according to the invention, it is not even necessary to identify the bottle of wine as such for greater security, but a negative identification “there are no bananas” is sufficient. The product is then marked in the list as “insufficiently recognized” and must be checked manually at the checkout.

In the case of products from the fruit and vegetable sector, the outlines of the products can advantageously be evaluated. In the “Beverages” section, many items have exactly the same outline, such as beer bottles. Here, the evaluation of the outline data quickly gives the result “beer bottle”. In order to differentiate between the individual types of beer from different breweries, the next step is to identify the color of the main label of the bottle.

The methods mentioned above can therefore advantageously be trained by machine learning on the products available in the retail store and then used for automated image recognition of the products. In this case, a degree of correspondence is determined by the aforementioned image comparison of the actual image data recorded when products are placed in the cart with target image data stored for the products in the database. Together with other sensor data, this degree of image agreement flows into a summary confidence assessment, which is decisive for the quality of the products recognition and for the assessment of whether a product is marked as insufficiently recognized in the digital product list of the shopping cart. The other sensor data mentioned can be, for example, measured weight data of the products, the location of the cart in the shop and other data.

The present invention solves a central problem with regard to the conventional digital shopping carts in retailing, since customers usually have no training whatsoever for such a system and their technical understanding is far from sufficient for problem-free use of the system. This causes many customers to fail in the shopping journey because they do something wrong but don't understand what they did wrong. The method according to the invention solves precisely this problem, among other things. The customer can make mistakes, but these can be identified at the checkout in a very short time, which means that the customer can use the system even with small errors, but the retailer does not lose any security. As a result, the retailer can draw massive advantages from the technology. Experience shows that a state-of-the-art digital shopping cart is only used for sales shares of around 10-15%. The rest of the sales are generated by classic, non-digital shopping carts. By increasing customer convenience using the present invention, usage is estimated at 25 to 30% of revenue. This leads to significant cost savings. This is only possible if the customer is allowed to make mistakes that can later be easily, simply and efficiently found and corrected with the control method according to the invention.

### DRAWINGS

Exemplary embodiments of the invention are illustrated in the drawings using a digital shopping cart, as is commonly used in food retail stores, and explained in more detail in the following description.

FIG. 1 shows a schematic structure diagram with the essential components that are used in carrying out the method according to the invention in accordance with a preferred exemplary embodiment.

FIG. 2 shows a schematic structure diagram with the essential components that are used in carrying out the method according to the invention in accordance with a second preferred exemplary embodiment.

FIG. 3 shows a schematic side view of a shopping cart with products weighing function with a scan box according to the invention mounted on it according to a preferred exemplary embodiment.

FIG. 4 shows the back of the scan box from FIG. 3, with a camera installed there as an example.

FIG. 5 shows excerpts of the display content of the scan box from FIGS. 3 and 4, at the moment when a control step according to the invention is carried out after a product has been recognized insufficiently, with other products in the shopping cart not being shown in order to increase the clarity of the figure.

FIG. 6 shows a schematic flowchart that includes essential steps of the control method according to the invention according to a first preferred exemplary embodiment, in which it is carried out in the checkout area through the scan box of the shopping cart after the purchase has been completed.

FIG. 7 shows a schematic flowchart that includes essential steps of the control method according to the invention according to a third preferred exemplary embodiment, in which the shopping person is given the opportunity to correct an insufficiently recognized product in the store.

FIG. 8 shows a schematic interaction flowchart that includes essential steps of the inventive control method according to a further preferred exemplary embodiment, in which the method is carried out in the checkout area by a cash register check module installed separately at the checkout after completing the purchase.

### DESCRIPTION OF THE EXEMPLARY EMBODIMENTS

In the figures, the same reference symbols denote the same components or components with the same function.

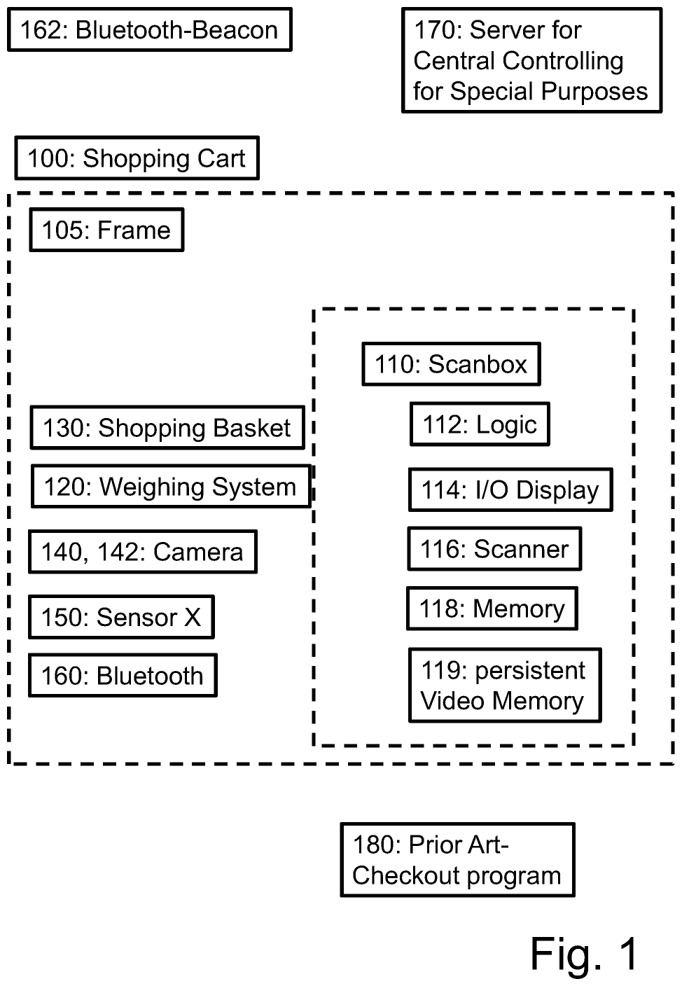

FIG. 1 shows a schematic structure diagram with the essential components that are used in carrying out the method according to the invention in accordance with a preferred exemplary embodiment. All components shown are connected to each other via the store's WiFi.

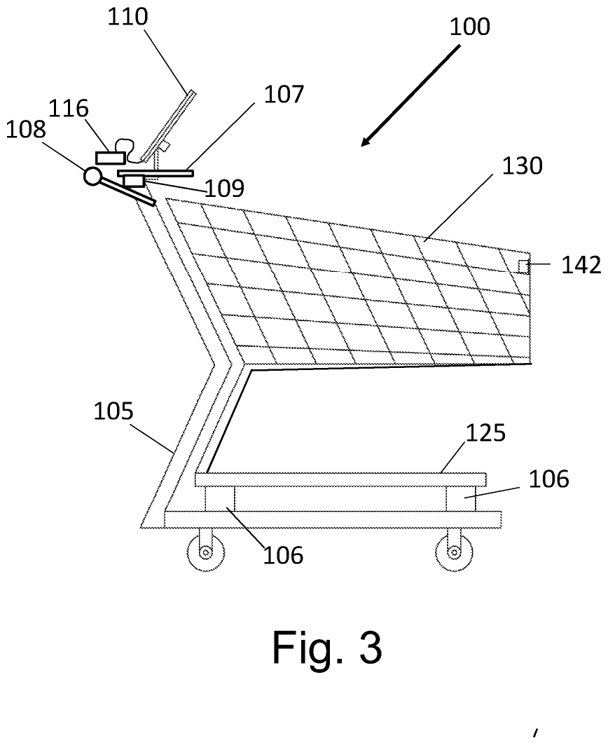

With additional reference to FIG. 3, a shopping cart 100 equipped in accordance with the invention includes a frame 105 mounted on four casters with three load cells 106 forming the first part of a weighing system 120, only two being shown for clarity because of the side view. The three load cells span a triangle that includes as large an area as possible. A shelf 125 made of a thick wire mesh for crates of drinks or other large-volume products is permanently mounted on the load cells 106. Supported by the storage surface 125 and stably connected to it, a basket carrier 126 running vertically upwards is attached. It bears the weight of the basket 130 stored on it. This basket is open on its upper side and consists of a wire mesh as usual. The second part of the weighing system 120 is a products scale 107, which is designed as a shelf on a crossbar 109 near the handle bar 108 and measures the weight of a product when it has been placed on the products scale by the customer.

In a further, particularly preferred exemplary embodiment, the products scale 107 can be omitted if the load cells 106 of the weighing system can also measure low weights, such as approximately 3 grams, with sufficient accuracy if the shopping cart already contains products with a total weight of approximately 100 to 150 kg. The separate step in which the customer should weigh each product before he puts it in the shopping cart can then also be dispensed with. Such load cells are commercially available, for example, from:
https://www.bosche.eu/scale components/weigh cells/platform-weigh cells/platform-weigh cells-h20a

The shopping cart 100 further includes a computer unit, referred to herein as a “scanbox” 110, mounted on a handle bar of the frame, for example as disclosed in patent applications US 2015/0206121 A1 or DE 10 2018 132 059 A1, the contents of which are incorporated herein by reference. The computer unit equipped according to the invention is fixedly mounted on the frame 105. In addition to the usual hardware such as CPU and memory 118, it contains, among other things, the programmed logic 112 in order to run the method according to the invention during shopping. A touch display I/O unit 114 is attached to the front of the scan box facing the customer and provides a robust input and output interface for the customer. A handheld scanner 116 is permanently and stably connected to the scan box 110 with a cable connection and cooperates with the logic 112 in capturing the codes applied to the products, mostly barcodes. Alternatively, a camera can be used to capture the barcode on the products or a scanner that is permanently installed in the scan box.

Two cameras 140 and 142 are fixedly mounted at the front and rear upper edges of the shopping cart. While shopping, they continuously take pictures and films in the area of the top of the shopping cart through a suitable lens. One of the cameras is preferably attached to the rear of the scan box 110.

In other exemplary embodiments, further cameras are attached, for example one on each side of the walls of the basket and one or two in the lower area of the storage grid for large-volume products. The images coming from the individual cameras are processed in a synchronized manner by the programmed logic 112. If necessary, the number of cameras can also be larger in order to be able to detect deliberate manipulations more easily. In the normal case of simply forgetting to scan the products before inserting them, two cameras are usually sufficient.

According to the invention, a memory area 119 is now provided in which only those video data showing the insertion of such products into the basket of the shopping cart that were rated as “insufficiently recognized” are permanently stored, at least until the products have been paid for by the customer. Since only short videos are stored in this memory 119, which show a short placement process of a product, this memory area 119 is called “short video memory”. This short video memory 119 is large enough to film the short videos mentioned in a suitably high resolution for a specified maximum number of insufficiently recognized products, so that individual “frames” of these videos can also be used for automated, image-based products recognition. For example, a video sequence has a storage space of 50 Mbytes, and a maximum of 20 insufficiently recognized products are expected per purchase. This would result in a memory requirement of approximately 1 GB for the short video memory 119. If, contrary to expectations, the memory requirement for a special purchase turns out to be greater, the logic 112 can access the memory on the server 170 in the store via WLAN.

Another “Sensor X” 150 symbolizes one or more sensors that provide data that can be useful for detecting the products that have been laid in. Examples include:

A microphone that can distinguish the impact of a hard object such as a glass bottle from that of a soft object, a vibration sensor that works together with the weighing system and only activates the scales when vibrations registered on the shopping cart have subsided, a brightness sensor, a heat sensor, etc.

A Bluetooth system 160 transmits and receives Bluetooth signals to and from Bluetooth beacons 162 installed in the store, thereby tracking the current location of the cart within the store floor. The location data is continuously recorded and stored separately synchronously with the recognition data described below. Instead of Bluetooth, other suitable transceiver systems can also be used.

A server 170 resides in the store and is operatively connected to the logic 112 software of each individual shopping cart via WLAN. A program component of the server 170 according to the invention records the respective digital product lists of the currently used shopping carts during the runtime of the purchases. It controls the smooth running of the programs in the respective scan box 110 and can intervene if technical components fail, for example if a camera is permanently covered or if there is an attempt to defraud, for example by activating a flashing light on the shopping cart and outputting, that the customer in question should use a conventional shopping cart, or advises an employee in the checkout area to subject this customer to a full check.

When the purchase is finished because the last products have been laid in, a software component of the logic 112 runs in the scan box 110 according to the invention, which offers the insufficiently recognized products for manual re-registration. Details are described below. If all the products have been recognized correctly, the list of products is transferred to a conventional checkout program 180 and the actual payment process with the customer is processed, as is known in the prior art.

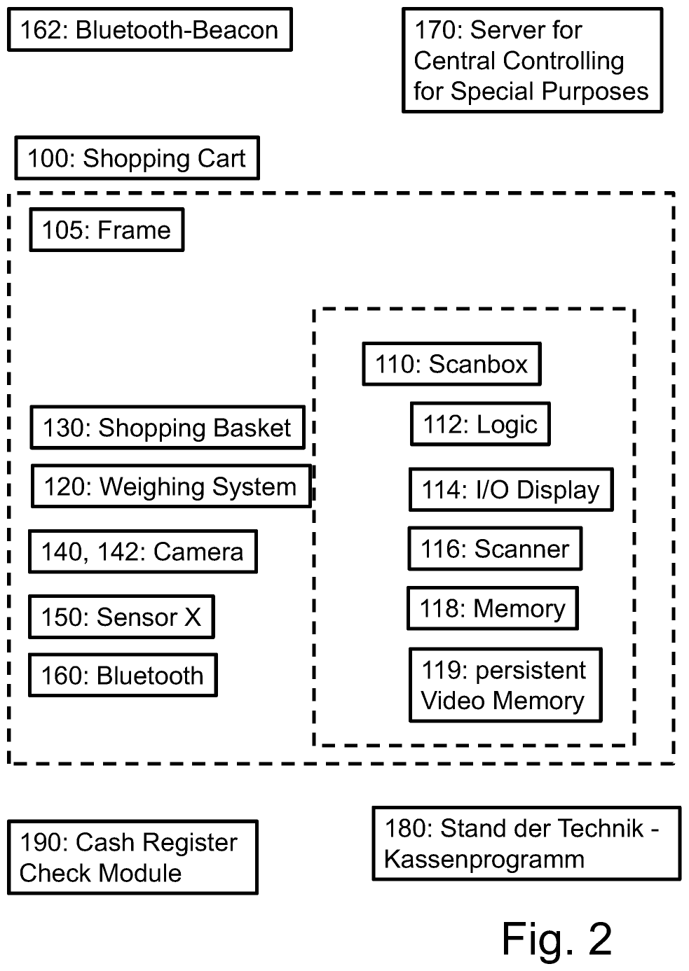

FIG. 2 shows a schematic structure diagram with the essential components that are used in carrying out the method according to the invention in accordance with a second preferred exemplary embodiment.

This differs from that in FIG. 1 in that a cash register check module 190 implemented at the checkout takes over the follow-up inspection and follow-up registration of the insufficiently recognized products instead of the software component of the logic 112 in the scan box 110. The product list of the current shopping cart equipped with an individual shopping cart ID is transmitted to the cash register check module 190 via WLAN or RFID tag, as is a link to the short video saved separately for each insufficiently recognized product, which shows the associated placement process of the product.

The customer should weigh the product before or after the product label is scanned, in any case before he places it in the basket 130.

In a special, preferred exemplary embodiment without a separate products scale, the load cell system takes over the precise determination of the products weight of each product laid-in. The load cells are so sensitive that a small load of at least 3 grams on the basket can be measured and further processed by inserting a very light product even when the basket is fully loaded with, for example, 100 kg.

In the exemplary embodiment with separate products scales, the weighing measurement data are forwarded from the weighing system 120, ie from the load cells 106 and from the products scales 107, to the scan box 110 for further processing via a hidden and protected cable connection or via an encrypted wireless connection. This uses the logic 112 to determine the total weight of the shopping basket, including all the products in it, from this data. The weight of the last inserted products results from the weight before placing the current product by calculating the difference. This should match the reading from the products scale 107.

In addition to the bar code or another code and one or more images of the product possibly captured by a camera 140, 142, the weight of a product serves as an additional criterion for classifying a product and registering it correctly.

The display of the Scanbox 110 shows the customer all the information that is important to him, in particular the properties of the product last placed, his digital product list, which lists all products placed in the shopping cart or on the shelf below with plain text and price, as well as a field for important instructions to the customer, where he can also make entries such as “YES”/“No”/“Cancel”/“Help”. In particular, the customer is notified when a product has been placed in the basket 130 that has not been recognized with sufficient clarity. He can then re-registrate the product by pressing a control element. According to the invention, however, he can also skip the re-registration. A message then appears that the product will be registered at the checkout.

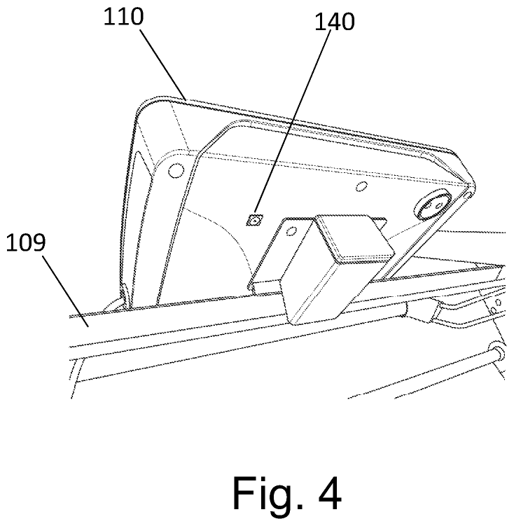

FIG. 4 shows the back of the scan box 110 from FIG. 3, with a built-in camera 140.

The camera 140 is aligned in such a way that it captures the entire shopping basket and its upper edge as an image section with a little overhang. If products are on top of each other, it may be that the products underneath are covered, but this is tolerable because camera 140 shows in particular the placement process of a product, which is always visible in the placement process and not covered by any other product, because the products are actually laid in from above. If the customer places an item on the lower shelf 125 when the bottom of the actual shopping cart 130 is already fully covered, the placement process is captured by one or more cameras additionally attached to the frame 105 and constantly moving along.

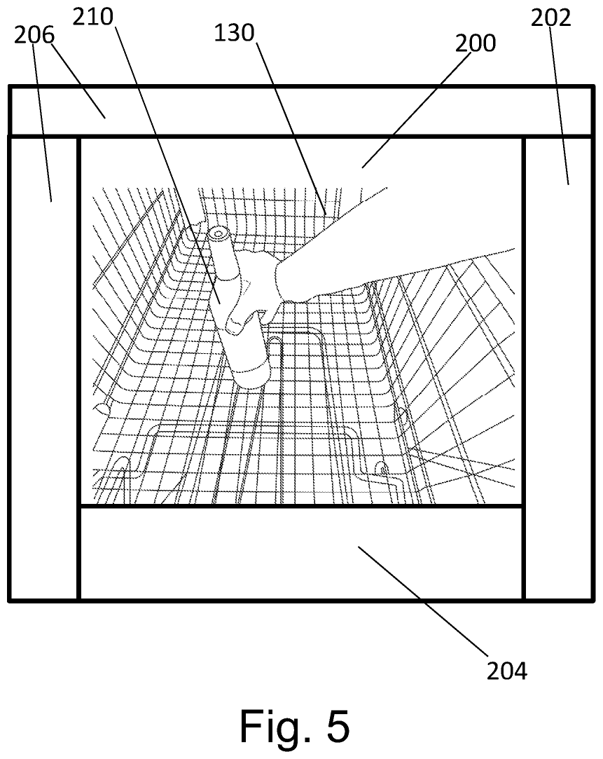

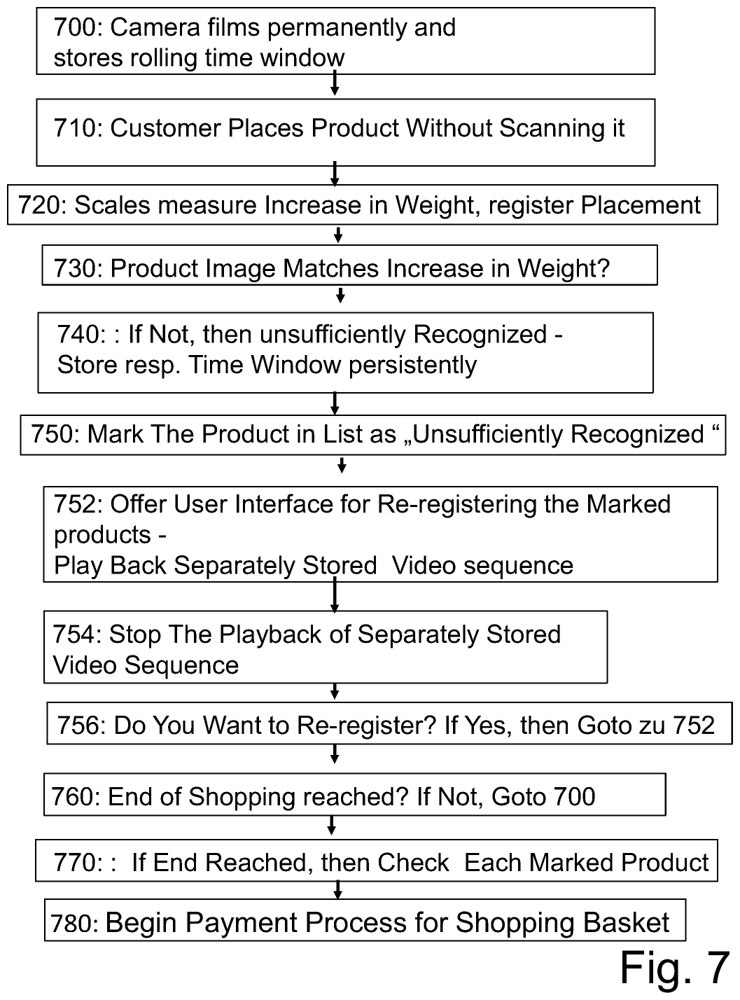

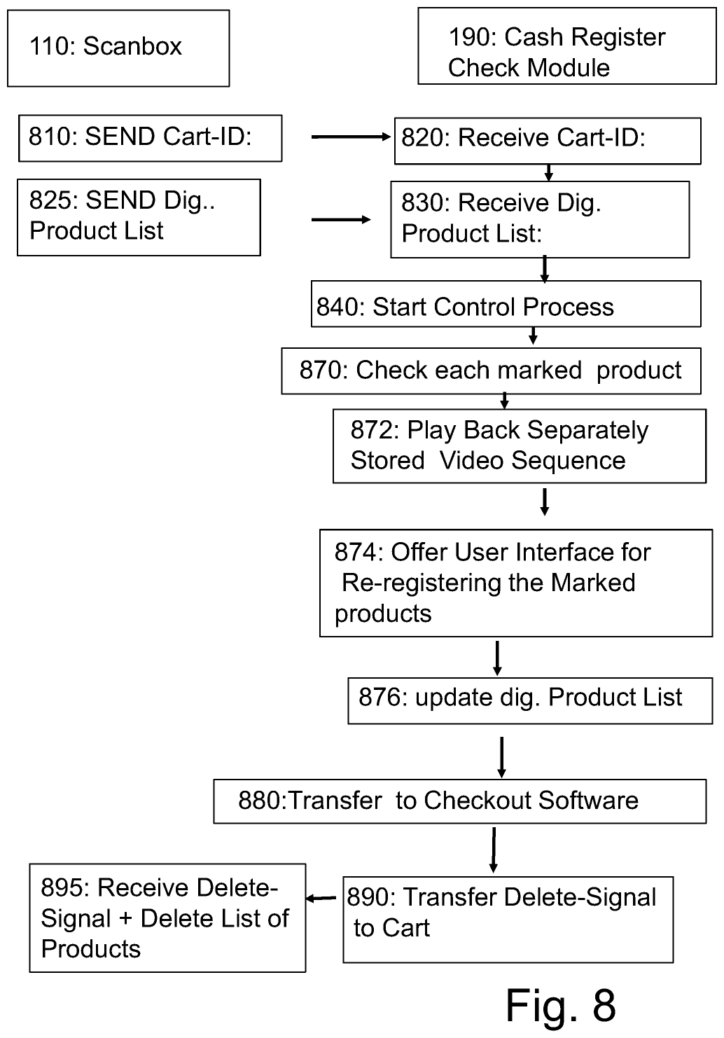

FIG. 5 shows the display content of the scan box 110 from FIGS. 3 and 4 at the moment when a control step 752 in FIG. 7 or 852 in FIG. 8 according to the invention is carried out after an insufficient product recognition.

In particular, a large sub-area of the display is filled with an image field 200, which is used to play back short videos that show the upper area of the shopping cart while the products are being laid in. In particular, you can see one arm of the customer holding the product in his hand and placing it in the shopping cart.

Another sub-area 202 shows the digital list of products, in which the products already registered are listed. The customer can navigate within the list and click on individual products. Another sub-area 204 shows details of the products such as real name, weight, and any item number that is currently clicked on in the list of products. Further partial areas 206 can be used for other purposes, such as a specific advertising reference or status reports from the logic 112, which could read, for example:
“Scanned products do not match the expected products weight—please repeat the process!”
   or
“A product weighing 451 g was laid in without a scan—please scan the product!”

Depending on the complexity, the information mentioned can also be represented graphically by corresponding symbols in one of the display areas 202, 204, 206.

If products are placed in the basket without scanning and without being weighed in wagon 107, an error message appears in the list of products with the meaning “non-registered article”.

In the cases mentioned, the customer can click on it and will be shown a short video in the large part of the display, which shows exactly the lay-in process of this “unregistered product” or product that has not been sufficiently recognized. The employee at the checkout or the customer himself can then remove the product visible on the video from the basket, scan it and lay it back in.

Another section of the display, on the far left, shows the status of the current check and the status of any re-registration of a product by the customer.

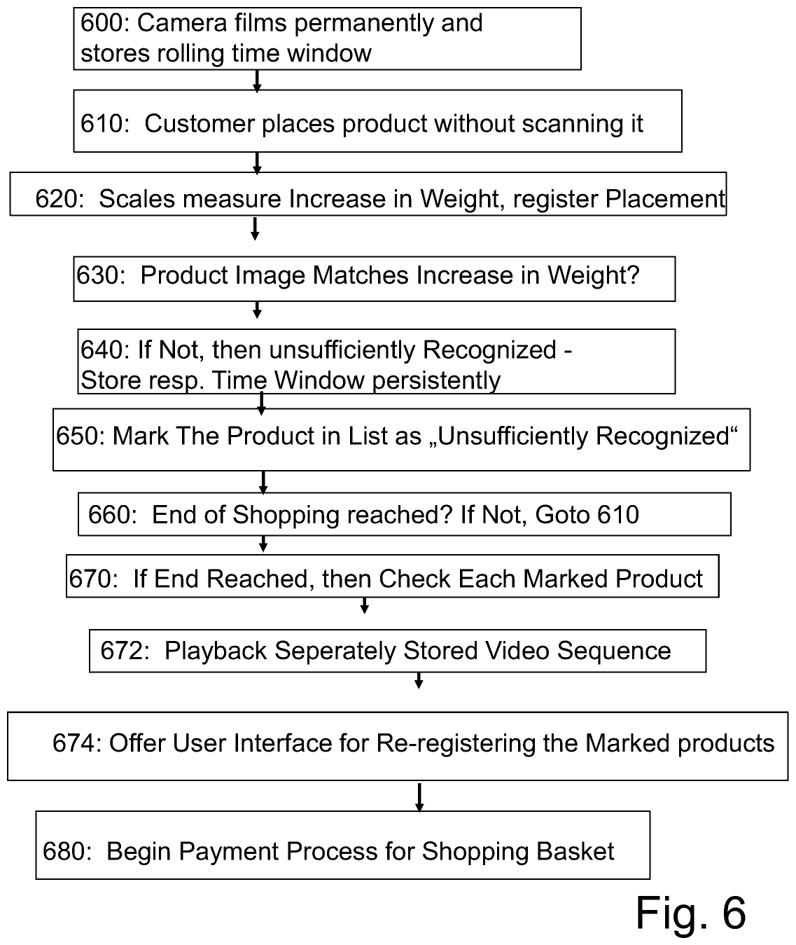

FIG. 6 shows a schematic flowchart that includes essential steps of the control method according to the invention according to a first preferred exemplary embodiment with image recognition, in which it is carried out in the checkout area through the scan box of the shopping cart after the purchase has been completed.

In a first step 600, the program is started and the cameras are activated. They store what is recorded in a rolling time window of around two minutes. The memory area is therefore constantly being overwritten. The actual past is therefore always accessible for the duration of the specified time window.

In a step 610, a customer now lays in a product without scanning it and without weighing it separately. Or the customer lays in a product identified by the scales as incorrect item into the shopping cart by scanning a product A but laying in a product B.

The weighing system always measures an increase in weight in the cases mentioned, which is linked to the laid in product and thus registers the placement of a product in a step 620.

The logic 112 now checks in a step 630 whether one or more images taken when the product was laid in is/are sufficiently clear to determine the product from the image(s) in combination with the weight increase.

If this is not the case, then in a step 640 the video data and, if available, the image data mentioned, which show the insertion process, are stored separately, namely persistently for the period of time during which the customer is shopping. In a step 650, the product currently laid in is marked as “insufficiently recognized” in the customer's digital product list.

In above mentioned case where the scan of product A does not match the weight of product B, the scan box informs him that he should registrate the product again. If the customer ignores the notice, the item will be marked as “insufficiently recognized” in the list of products, and the list will mention “wrong item”. When the marked products are processed at the checkout, the video sequence appears in which the employee can see which products were laid in incorrectly.

This scheme continues until the purchase is complete and the customer enters the checkout zone. An automated check process 670 now begins as to whether all products in the customer's digital product list have been recognized sufficiently well. This is conveniently checked by searching the list for products that were marked in step 650 above. The start of this check is triggered by manually pressing a button “Check shopping now” on the scan box 110. Alternatively or in combination, this can also be done automatically after the shopping cart has reached a “checkout zone”, which is caused by a signal exchange between a Bluetooth beacon at the beginning of the checkout area together with the Bluetooth system on the shopping cart.

If the checking process 670 encounters a product marked as “insufficiently recognized” in the product list, then in a step 672 the separately stored video sequence is played back automatically in the display of the shopping cart, which was recorded when this product was placed in the shopping cart. The customer or the checkout staff can see immediately which products have to be re-registered, can pick these products in the shopping cart, take them out and re-registrate them, for example by manually scanning the barcode. For this purpose, a corresponding button opens automatically, which prompts you to registrate the products. The weighing system 120 installed in the shopping cart registers a decrease in weight, which should correspond to the weight of the product removed. This serves to provide additional security when registering the product.

With sufficiently sensitive weighing cells 106, this re-registration is designed in such a way that the customer or the cashier takes products that are to be re-registered from the shopping basket, scans them and puts them back in. In the case of less sensitive load cells 106, this must be done by weighing the products separately on scales 107, or on another scale that may be located in the checkout area. This process ensures that all products that have been purchased have been weighed. In this way, the product database can be filled with the actual weight information, which, once there is a sufficiently large number of details, makes the automated product recognition for a specific product group better and better.

This flowchart with the steps 672 and 674 is carried out for all products marked as “insufficiently recognized”.

The customer can correct errors in the re-registration of products in the list of products at any time, even without a camera, as described below:

If the customer or the user of the shopping cart according to the invention lays a product in without being recognized, the scan box 110 issues an error message. Suppose the user ignores this and captures the next item. The unregistered product now appears in the list as “unregistered product”. The user now has the opportunity to correct this at any time. This can be directly after the second item, but also later, for example, after he has correctly scanned and laid in ten more items, for example. The customer/user becomes aware of the “non-registered products” in the digital product list, looks into the basket and could immediately see: “That must have been the toast”. Logic 112 had determined and stored that, for example, 453 g had been inserted unregistered at a certain position in the digital product list. The customer/user now removes the toast and the logic 112 registers that 453 g has been removed from the shopping cart. The “unregistered product” then disappears from the list immediately. The user can now scan this article correctly. He has thus corrected his recognition error without the need for a camera, because the cart can allocate the named products via the non-registered, laid-in weight, which is later removed again.

The customer or user can even retrospectively assign a later registration process. In the example mentioned, the user does not even take the toast out of the cart basket, but takes the mobile hand-held scanner and scans the toast lying in the cart basket. The logic 112 then registers that the 453 g that has just been scanned exactly match the product that was laid in as an “unregistered item” ten registration processes ago, for example, and now assigns the toast to it. In this way, too, the digital list of products is in the correct state again. A so-called “retrospective article assignment” is thus made possible.

Optionally, the short videos can serve as additional assistance for the last-mentioned variants.

If all the products have been recognized sufficiently well, then the list of products, including prices, is transferred to a checkout program that is already available in the shop and the payment process is started as usual, step 680.

According to the invention, digitally supported shopping that can be carried out quickly is thus made possible, which is very customer-friendly, because the inventive, automated method for recognizing and tracking products that are placed in the shopping cart of a digital shopping cart when shopping is “yielding” for the customer, since it does not insist on a correcting recognition of the products to be carried out immediately when the products are placed in the shopping cart, but allows the customer to continue shopping in peace, even if something should not have worked when entering a product. At the same time, the checkout staff can very quickly and easily check the entire shopping basket and manually “pick out” unsufficiently recognized products from the “pile of products” in the basket, without having to carry out a laborious and time-consuming comparison of the list of correctly recorded products with the products in the shopping basket, which in the first place only serves to discover products in the shopping cart that have not been recognized in the “pile of products”.

In a further preferred exemplary embodiment, the inserted products are identified without image processing using only the scan and are checked using the registered weight of the products. This presupposes that the product database stores an expected weight of each product, including a specified tolerance range, and keeps it ready for query when the product is scanned. The products database therefore stores a tolerable “weight range” for each product as the expected weight of the product. Does the scan code and the measured weight match the expected weight of an laid-in product, then the product is considered to be correctly recognized. If there are discrepancies, the product is marked as “not sufficiently recognized” in the customer's list of products. If the customer lays in an item without scanning it, analogously to step 610, the scales and/or the load cell system registers the placement of an item, analogously to step 620 and, analogously to step 674, requests rescanning. By storing the actual, measured weight information in the database often enough when the scan is correct, the tolerance range of the weight of each product or group of products can be tightened over time through the operation of the method according to the invention, by the tolerance range being slightly decreased from its initial values after a sufficiently large number of measured weight information.

In the following, some specific examples of an automated confidence assessment for a specific product are given, which are carried out in the method according to the invention when assessing whether the product that has been placed in the shopping cart without scanning it is rated as “insufficiently recognized” and is marked accordingly in the digital product list of the customer. The confidence rating is based on a percentage scheme that allows percentage values between 0% for “completely insufficiently recognized product” and 100% for “very reliably recognized product” continuously or in finer steps than those shown below. As “sensor data” within the meaning of the invention only measured weight data of the product are used, which have been measured by the products scales 107 or the load cells 106 and have been determined by calculating the difference between two measured shopping basket weights before and after the product has been placed in the shopping basket. Each product or product group has a tolerance range for its expected weight, which is stored in the product database. This range naturally varies in size depending on the products, both in relative terms and in absolute weight terms, which is particularly the case for products in the fruit and vegetable sector, for example.

Alternatively or in combination, the images of the products recorded by a camera are used. These are preferably those “frames” of the video sequence recorded by an “on-board camera” 140, 142 of the shopping cart that are most revealing for the recognition of a product, i.e. for a bottle, for example, those frames that at least partially show the front label of the bottle, or for an outer packaging of a product, the top of which shows the manufacturer and/or the product brand.

Confidence range 0%-30%:

Such a low confidence means that the scan is almost certainly wrong or has not been done;

A wine bottle, for example, is assigned to this confidence range if the weight deviation between the target and actual weight is greater than 3%, or if the automated image recognition shows a match only between 0% and 30% between a “target image” in the products database “of the product (or several of them) and the recorded image of the product. Here, the method according to the invention forces a manual check by the cashier at the checkout.

Confidence range 30% to 50%:

To this confidence range for example a 10-eggs box is assigned, if the weight deviation between the target and actual weight is greater than 10% and the automated image recognition shows that one of the target images from the products database and the recorded image match between 40% and 70%. Here, the method according to the invention forces a manual follow-up check.

Confidence range 50% to 70%:

A bottle of olive oil, for example, is assigned to this confidence range if the weight deviation between the target and actual weight is greater than 4% and the automated image recognition results in a 50% to 80% match between one of the target images from the products database and the most informative recorded image. Here, the method according to the invention forces a manual follow-up check.

A box of chocolates, for example, is also assigned to this confidence range of 50-70% if the weight deviation between the target and actual weight is less than 3% and the automated image recognition shows at least a 60% match between one of the target images from the products database and the most informative recorded image results. Here, the method according to the invention forces a manual follow-up check.

70% to 90% means: a pre-packaged piece of cheese, for example, is assigned to this confidence range if the weight deviation between the target and actual weight does not exist and the automated image recognition yields at least 90% agreement between one of the target images from the products database and the most informative recorded one. Here, the method according to the invention forces a manual follow-up check.

Or: a box of chocolates, for example, is assigned to this confidence range of 70-90% if the weight deviation between the target and actual weight is less than 3% and the automated image recognition yields at least a 80% agreement between one of the target images from the products database and the most informative recorded one. Here, the method according to the invention forces a manual follow-up check.

90% to 100%:

A pack of coffee, for example, is assigned to this confidence range if the weight deviation between the target and actual weight is less than 3% and/or if the automated image recognition results in at least 90% agreement between one of the target images from the products database and the most informative recorded image. Here, the method according to the invention does not require any manual re-checking.

FIG. 7 shows a schematic flowchart that includes essential steps of the inventive control method according to a third preferred exemplary embodiment, in which the shopping person is given the opportunity to correct the registration of an insufficiently recognized product in the store before entering the checkout area. Steps 700 through 750 correspond to the description of steps 650 through 650 and FIG. 6.

It is now assumed that the customer would like to do a correcting registration of the “insufficiently recognized product”. He sees this product in his digital list of products on the scan box display as “unregistered product”. The customer can click it there, step 752. As soon as he does this, the stored short video is shown on the display and shown repeatedly if necessary. With this information, the customer can pick up the product shown there, he can weigh it separately on the products scales 107—if necessary if the load cells 106 are not sufficiently sensitive—and scan them again. If a comparison between target weight and actual weight and a comparison between the target image and the recorded actual image of the products yields a sufficiently high level of confidence, the product is stored in the list of products as “sufficiently recognized”. The video sequence is then stopped, step 754. The previous “not sufficiently recognized”—flag is deleted. If the confidence level is too low, the product remains marked as “insufficiently recognized” in the list of products. The video sequence is then also stopped, step 754. The method is then ready to recognize the next item, see steps 700 ff. and to continue or end the purchase, see steps 756, 760, 770 and the description of FIG. 6.

FIG. 8 shows a schematic interaction flowchart that includes essential steps of the method according to a further preferred exemplary embodiment, in which the method is carried out in the checkout area by a cash register check module installed separately at the checkout after the purchase has been completed.

It is assumed that the customer would like to complete his purchase and that he may have products in his shopping cart which have not been recognized sufficiently. Four cash registers, for example, are arranged in the checkout zone. Each has a cash register check module 190—see FIG. 2—as a hardware-software combination. This includes essentially the same checking functionality for checking a digital list of products as the scan box 110 on the shopping cart. When the customer's turn comes and he has access to one of the cash registers, his shopping cart automatically sends its shopping cart ID, also known as Cart ID, to the cash register check module responsible for him via NFC communication or other wireless transceiver protocol, step 810. Cash register check module 190 receives the Cart ID. Likewise, the customer's digital product list is transmitted via WLAN to the control server 170 of the store, step 825. The cash register check module 190 retrieves the cart ID from the server 170 and receives it via WLAN, step 830.

This cart ID can, for example, also be a four-digit or multi-digit number that is attached to the front of the shopping cart in a legible manner and is entered manually by the checkout staff.

The cash register check module 190 now starts the control process with which products marked as “insufficiently recognized” are to be re-registered in the list of products in the cart ID, step 840.

Thereafter, the user interface for re-registering the product is offered for each marked product by means of the video sequence played-back in step 872, which shows the process of placing it in the shopping cart, step 874. This is then always done by the checkout staff, also in difficult cases in the event of a damaged or illegible scan code, if necessary by entering the article number. The digital product list is updated by deleting the flag, step 876.

After repeating this process for all marked items, the cash register check module sends the corrected digital product list to the point-of-sale software, step 880, for payment by the customer.

After the customer has paid, the digital list of products is forwarded to the merchandise management system and then deleted from the scan box 110 together with the rolling or persistently stored data, step 890, with a copy optionally being stored separately on the server 170 for complaint purposes for a limited period of time. The scan box 110 is then again ready for the next purchase.

The subject matter of the present invention can be implemented in hardware, software, or a combination of both. Any type of computer system or computer device is suitable for carrying out all or part of the method according to the invention. A typical hardware-software combination for the present invention would be a tablet computer attached to a shopping cart, with a portable scanning unit for detecting merchandise using a scannable code, with an operatively coupled or coupleable connection to a camera on the shopping cart attached to the upper area of the basket, a main memory for storing a program code that can carry out the individual steps of the claimed method in whole or in part, with a WLAN module for connecting to a server computer in the shop that houses the shopping cart and many other shopping carts of the same type is assigned, which can run a merchandise management system, and a Bluetooth module for locating the shopping cart using Bluetooth beacons suitably placed in the sales area.

The present invention may also be embodied in a computer program product which includes all features enabling the methods described herein to be implemented and which, when loaded into a computer system, is capable of carrying out these methods when the matching data is supplied.

Although the present invention has been described above on the basis of preferred exemplary embodiments, it is not limited thereto but can be modified in many different ways.

The temporary storage and overwriting, described as rolling, can also take place in such a way that at least two consecutive sequences are always kept temporarily stored and the first is not overwritten until the third sequence. Depending on the available storage space, this scheme can also be extended.

A second monitoring scheme of the digital list of products that is not recognizable to the customer can also run parallel to the method described above, only in the background, which compares the actual weight information that the weighing system 120 delivers via the load cells 106 and/or the products scale 107 with the weight of the products stored in the products database. If there are noticeable differences in weight, a message may appear that the products must be checked manually in the checkout area. If the products weigh significantly more than expected, then there is a suspicion that a smaller item was placed into the outer packaging. If it weighs significantly less, it is possible that individual parts of the products have been removed, for example an egg in a pack of 10 may be missing. In both cases, it is also possible to check whether there is an incorrect, possibly very high-priced item in the scanned outer packaging of low-priced product.

If the customer puts an product in the basket, but at almost the same time within 0.5 seconds, for example, removes another product from the shopping cart that has already been recognized or not yet recognized, or if the customer places several items in the shopping cart at the same time that he has not previously scanned individually, then the method according to the invention also indicates an “unregistered product” in the list of products and stores the video sequence in the short video memory 119.

In addition to the systems mentioned, such as WLAN, Bluetooth, NFC, all suitable systems and protocols that are known in the prior art can be used as communication systems, provided they are suitable for the specific application as described here.

Finally, the features of the subclaims can essentially be freely combined with one another and not through the order in which the claims are presented, provided they are independent of one another.

1. Method for recognizing and tracking products that are placed in the shopping basket of a digital shopping cart or a picking cart, including the steps:
a) permanent recording of image data of the shopping basket by a camera mounted on the shopping cart,
b) registering a placement process of a product into the shopping basket by means of automated evaluation of sensor data provided by sensors on the shopping cart,
c) carrying out an automated control process to determine whether the placed products have been recognized reliably enough,
d) if the control process reveals that a product has not been recognized or has not been recognized reliably enough, separately storing a copy of the recorded image data from a time period of a predetermined length which show the registered placement process, and
e) creating a marking for the product not recognized or not recognized reliably enough in a digital product list that represents the products placed in the shopping basket.

2. Method according to claim 1, wherein the image data are stored in a rolling manner during a time window of a predetermined length and previously existing image data are overwritten.

3. Method according to claim 1, wherein an automated confidence assessment, according to which a product is classified as recognized not reliably enough, is created on the basis of confidence data for the respective product recognition.

4. Method according to claim 1, wherein the sensor data are measurement data from a weighing system (120) which measures an increase in weight caused by the placement of the product.

5. Method according to claim 4, wherein predefined confidence ranges are evaluated for a product by a weight comparison between a predefined target weight of the product and its measured actual weight.

6. Method according to claim 5, wherein the actual weight of a product is separately stored in a products database if it has been recognized reliably enough.

7. Method according to claim 1, wherein the sensor data being the image data recorded during a placement process of a product.

8. Method according to claim 7, wherein predefined confidence ranges for a product are evaluated by an image comparison between the actual image data recorded when recognizing the product in the retail store and target image data stored for the product.

9. Method according to claim 1, further comprising the steps:
a) automated checking of the product list for the presence of products marked in the product list,
b) if a marked product is encountered, playing back the separately stored copy of the image data from a time period of a specified length, showing the process of placing the product in the shopping cart,
c) offering a user interface for separately re-registering the marked product.

10. A method according to claim 1, wherein the shopping cart is an order picking cart and the digital item list is an order picking list.

11. A method for recognizing and tracking products by a cash register check module, the products having been placed in the shopping basket of a digital shopping cart, comprising the steps of:
a) receiving an ID for the shopping cart, as well as a digital list of products that represents the products that have been placed in the shopping basket of the shopping cart,
b) automated checking of the list of products for the presence of products marked in the list of products, with the marking of a product representing a recognition process of a product not being recognized or not being recognized reliably enough when it is placed into the shopping cart basket,
c) when a marked product is encountered, playing back of the separately stored copy of the image data from a time period of a predetermined length, which shows the product placement process into the shopping cart basket,
d) offering a user interface in the checkout zone for separate re-recognition of the marked products.

12. Scan box for attachment to a shopping cart, containing:
an operational tablet computer
with I/O interfaces for recording image data of the shopping cart basket using a camera mounted on the shopping cart,
with I/O-interfaces for sensor data provided by sensors on the shopping cart,
with a memory for storing code sections and a logic unit for executing these code sections for performing respective steps of the method according to claim 1 when loaded for execution.

13. Digital shopping cart with a scan box attached thereto, according claim 12.

14. A computer product comprising a computer program for execution in a data processing system and residing on a non-transitory computer-readable medium, the computer program containing code sections for performing respective steps of the method according to claim 1 when loaded for execution.

15. A computer program product, stored on a non-transitory computer-readable medium, containing computer-readable program means for causing a computer to perform the method of claim 1 when the program means is executed by the computer.

16. Scan box for attachment to a shopping cart, containing: an operational tablet computer,
with I/O interfaces for recording image data of the shopping cart basket using a camera mounted on the shopping cart,
with I/O-interfaces for sensor data provided by sensors on the shopping cart,
with a memory for storing code sections and a logic unit for executing these code sections for performing respective steps of the method according to claim 1.

17. A computer product comprising a computer program for execution in a data processing system and residing on a non-transitory computer-readable medium, the computer program containing code sections for performing respective steps of the method according to claim 1 when loaded for execution.

18. A computer program product, stored on a non-transitory computer-readable medium, containing computer-readable program means for causing a computer to perform the method of claim 1 when the program means is executed by the computer.

19. A computer product comprising a computer program for execution in a data processing system and residing on a non-transitory computer-readable medium, the computer program containing code sections for performing respective steps of the method according to claim 11 when loaded for execution.

20. A computer program product, stored on a non-transitory computer-readable medium, containing computer-readable program means for causing a computer to perform the method of claim 11 when the program means is executed by the computer.
